(19) United States
(12) Patent Application Publication
(10) Pub. No.: US 2008/0315536 A1
(43) Pub. Date: Dec. 25, 2008

(54) ELECTROSTATIC CHUCK AND METHOD OF MANUFACTURING THE SAME

(75) Inventors: Masakuni Miyazawa, Nagano-shi (JP); Takashi Oonuma, Nagano-shi (JP); Masashi Ono, Nagano-shi (JP)

Correspondence Address: DRINKER BIDDLE & REATH (DC), 1500 K STREET, N.W., SUITE 1100, WASHINGTON, DC, 20005-1209, US

(73) Assignee: SHINKO ELECTRIC INDUSTRIES CO., LTD., Nagano-Shi (JP)

(21) Appl. No.: 12/142,014

(22) Filed: Jun. 19, 2008

(30) Foreign Application Priority Data
Jun. 22, 2007 (JP) 2007-165465

(51) Int. Cl. B23B 31/28

(52) U.S. Cl. 279/128; 156/52

(57) ABSTRACT

There is provided an electrostatic chuck. The electrostatic chuck includes: a ceramic base containing alumina and first flux; an electrostatic electrode built in the ceramic base; and a ceramic material containing second flux and provided between the ceramic base and the electrostatic electrode, the ceramic material contacting the ceramic base and the electrostatic electrode. A content rate of the second flux is higher than that of the first flux.

This application is based on and claims priority from Japanese Patent Application No. 2007-165465, filed on Jun. 22, 2007, the entire contents of which are hereby incorporated by reference.

### BACKGROUND

1. Technical Field

The present disclosure relates to an electrostatic chuck and a method of manufacturing the same and, more particularly, to an electrostatic chuck in which content rate of flux contained in a ceramic base is set to the level, at which the ceramic base is hardly damaged by plasma, and a method of manufacturing the same.

2. Related Art

The coating equipment (e.g., a CVD equipment, a PVD equipment, or the like) and the plasma etching equipment, which are used in manufacturing the semiconductor device such as IC, LSI, or the like, has the stage that is used to hold a semiconductor substrate (e.g., concretely a silicon wafer) in the processing chamber with good precision. As such a stage, for example, the electrostatic chuck is used. The electrostatic chuck includes the ceramic base formed of ceramic and flux, and an electrostatic electrode built in the ceramic base.

Recently, when the electrostatic chuck is used in the coating equipment (e.g., an Electron Cyclotron Resonance (ECR) equipment) using the high-density plasma and the plasma etching equipment as the coating equipment, such a problem has arisen that the flux contained in the ceramic base is removed by the plasma and thus the ceramic base is damaged.

As the electrostatic chuck to solve the above problem, there is an electrostatic chuck 200 as shown in FIG. 1.

FIG. 1 is a sectional view of an electrostatic chuck in the related art.

By reference to FIG. 1, the electrostatic chuck 200 in the related art includes a ceramic base 201 and an electrostatic electrode 202. The ceramic base 201 is used to build the electrostatic electrode 202 therein. The ceramic base 201 has a substrate mounting surface 201A on which the semiconductor substrate is mounted, and an opening portion 203 from which the electrostatic electrode 202 is exposed. The opening portion 203 is an insertion port through which feeding terminals (not shown) are inserted. The feeding terminals (not shown) are terminals used to feed a power to the electrostatic electrode 202. The ceramic base 201 is formed by laminating green sheets whose content rate of alumina is 99 wt % or more (the flux is remaining 1 wt % or less) and then burning them. A green sheet used in forming the ceramic base 201 is the green sheet whose content rate of alumina is higher than the common green sheet. The content rate of alumina of the common green sheet is about 96 wt %.

In this manner, when the ceramic base 201 is formed by using the green sheet whose content rate of alumina is high (the content rate of alumina is 99 wt % or more), the content rate of flux contained in the ceramic base 201 is reduced. Therefore, such a situation can be suppressed that the ceramic base 201 is damaged by the plasma.

The electrostatic electrode 202 is built in the ceramic base 201. The electrostatic electrode 202 is used to fix the semiconductor substrate to the substrate mounting surface 201A of the ceramic base 201 by an electrostatic force. The electrostatic electrode 202 can be formed by burning a conductive paste (e.g., W paste).

FIGS. 2 to 6 are views showing steps of manufacturing the electrostatic chuck in the related art. In FIGS. 2 to 6, the same reference symbols are affixed to the same constituent portions as those in the electrostatic chuck 200 shown in FIG. 1 in the related art.

A method of manufacturing the electrostatic chuck 200 in the related art will be described with reference to FIGS. 2 to 6 hereunder. At first, in steps shown in FIG. 2, green sheets 206 and 207 whose content rate of alumina is 99 wt % or more (the flux is remaining 1 wt % or less) are prepared.

Then, in steps shown in FIG. 3, a through hole 209 is formed in the green sheet 206. The through hole 209 will be the opening portion 203 shown in FIG. 1 when the structure shown in FIG. 5 described later is burned.

Then, in steps shown in FIG. 4, a conductive paste 211 (e.g., the W paste) is formed on a surface 207A of the green sheet 207. Then, in steps shown in FIG. 5, the green sheet 207 is laminated on the green sheet 206 such that a surface 206A of the green sheet 206 contacts the conductive paste 211.

Then, in steps shown in FIG. 6, the structure shown in FIG. 5 is burned. Accordingly, the electrostatic chuck 200 including the ceramic base 201 and the electrostatic electrode 202 is manufactured (see e.g., JP-A-11-312729).

However, in the electrostatic chuck 200 in the related art, the ceramic base 201 is formed by using the green sheets 206 and 207 whose alumina content is high. Therefore, the content rate of flux contained in the green sheets 206, 207 is reduced, and thus the flux content contained in the ceramic base 201 is reduced. Accordingly, the anchor effect is lowered in a joint portion between the ceramic base 201 and the electrostatic electrode 202. Therefore, such a problem existed that a joint strength between the ceramic base 201 and the electrostatic electrode 202 is lowered. In such a case, the electrostatic electrode 202 might be peeled off the ceramic base 201.

### SUMMARY

Exemplary embodiments of the present invention address the above disadvantages and other disadvantages not described above. However, the present invention is not required to overcome the disadvantages described above, and thus, an exemplary embodiment of the present invention may not overcome any of the problems described above.

It is an aspect of the present invention to provide an electrostatic chuck capable of improving a joint strength between an electrostatic electrode and a ceramic base that is hardly damaged by plasma, and a method of manufacturing the same.

According to one or more aspects of the present invention, an electrostatic chuck includes: a ceramic base containing alumina and first flux; an electrostatic electrode built in the ceramic base; and a ceramic material containing second flux and provided between the ceramic base and the electrostatic electrode. The ceramic material contacts the ceramic base and the electrostatic electrode. A content rate of the second flux is higher than that of the first flux.

According to one or more aspects of the present invention, in a method of manufacturing an electrostatic chuck, the method includes:

i) preparing first and second green sheets containing alumina and first flux;

ii) forming a first alumina past containing second flux on the first green sheet;

iii) forming a conductive paste on the first alumina past;

iv) forming a second alumina paste containing the second flux on the second green sheet;

v) laminating the first green sheet on the second green sheet such that the conductive paste faces and contacts the second alumina paste; and

vi) burning a laminated structure of the first green sheet and the second green sheet.

A content rate of the second flux is higher than that of the first flux.

Other aspects and advantages of the invention will be apparent from the following description, the drawings and the claims.

### BRIEF DESCRIPTION OF THE DRAWINGS

The above and other aspects, features and advantages of the present invention will be more apparent from the following more particular description thereof, presented in conjunction with the following drawings wherein:

FIG. 1 is a sectional view of an electrostatic chuck in the related art;

FIG. 2 is a view (#1) showing steps of manufacturing the electrostatic chuck in the related art;

FIG. 3 is a view (#2) showing steps of manufacturing the electrostatic chuck in the related art;

FIG. 4 is a view (#3) showing steps of manufacturing the electrostatic chuck in the related art;

FIG. 5 is a view (#4) showing steps of manufacturing the electrostatic chuck in the related art;

FIG. 6 is a view (#5) showing steps of manufacturing the electrostatic chuck in the related art;

FIG. 7 is a sectional view of an electrostatic chuck according to an embodiment of the present invention;

FIG. 8 is a view (#1) showing steps of manufacturing the electrostatic chuck according to the embodiment of the present invention;

FIG. 9 is a view (#2) showing steps of manufacturing the electrostatic chuck according to the embodiment of the present invention;

FIG. 10 is a view (#3) showing steps of manufacturing the electrostatic chuck according to the embodiment of the present invention;

FIG. 11 is a view (#4) showing steps of manufacturing the electrostatic chuck according to the embodiment of the present invention;

FIG. 12 is a view (#5) showing steps of manufacturing the electrostatic chuck according to the embodiment of the present invention;

FIG. 13 is a view (#6) showing steps of manufacturing the electrostatic chuck according to the embodiment of the present invention; and

FIG. 14 is a view (#7) showing steps of manufacturing the electrostatic chuck according to the embodiment of the present invention.

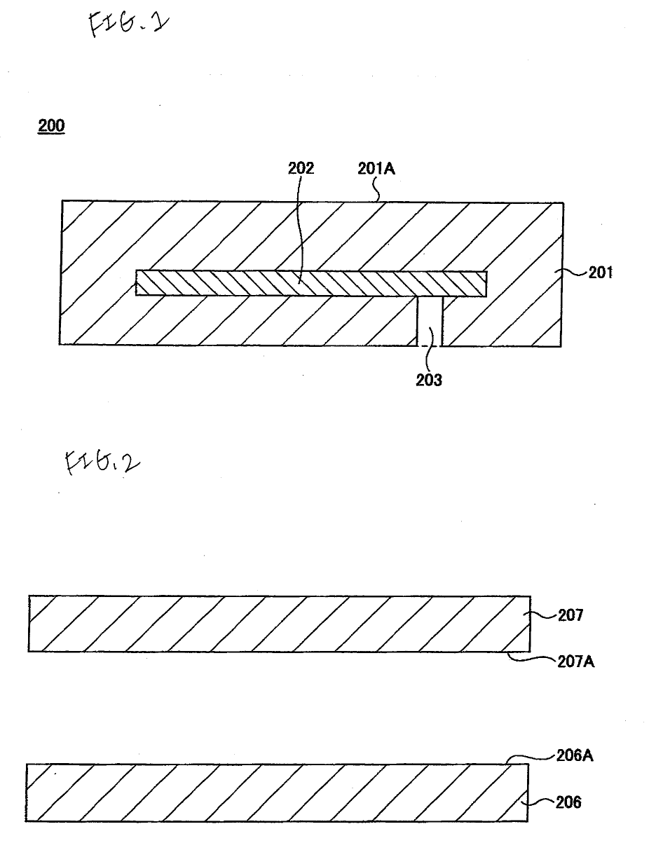

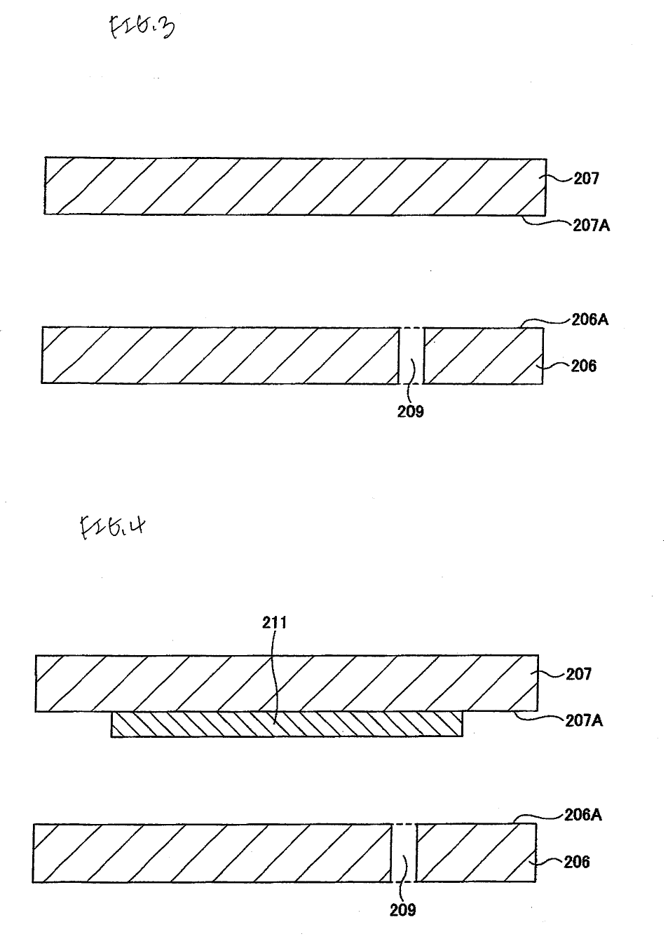

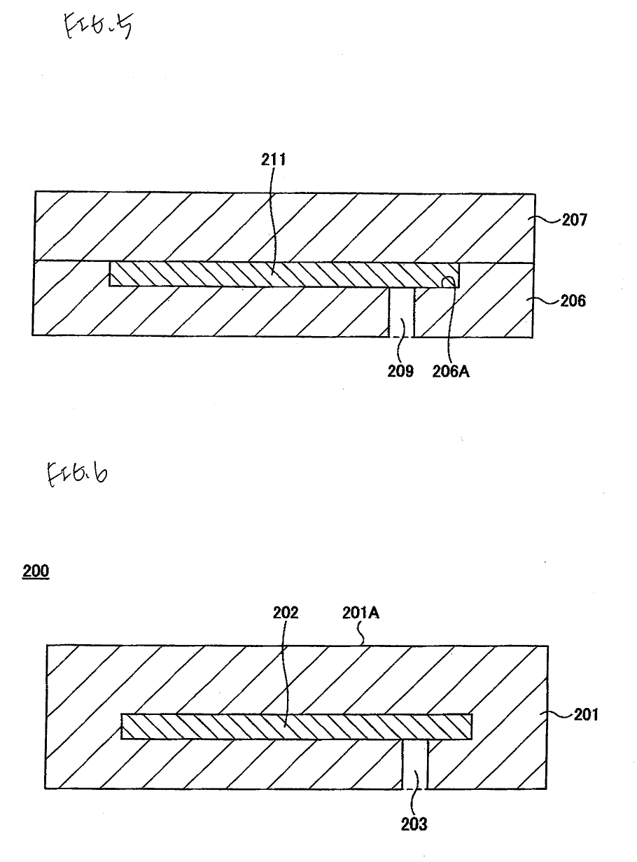

### DETAILED DESCRIPTION

Exemplary embodiments of the present invention will be described with reference to the drawings hereinafter.

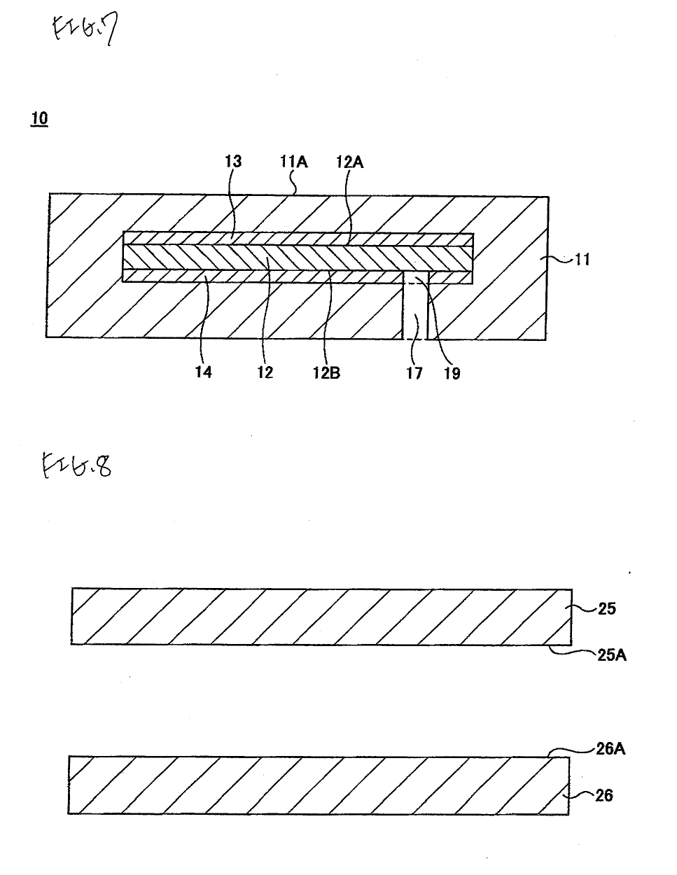

FIG. 7 is a sectional view of an electrostatic chuck according to an embodiment of the present invention.

By reference to FIG. 7, an electrostatic chuck 10 of the present embodiment includes a ceramic base 11, an electrostatic electrode 12, and ceramic materials 13, 14.

The ceramic base 11 has a substrate mounting surface 11A on which a substrate (e.g., a semiconductor substrate, a liquid crystal panel, or the like) is mounted, and an opening portion 17 into which a part of feeding terminals (terminals for feeding a power to the electrostatic electrode 12) (not shown) is inserted. The ceramic base 11 includes the electrostatic electrode 12 and the ceramic materials 13 and 14 therein. The ceramic base 11 may be formed of alumina, first flux, for example. The first flux may be formed of silicon oxide, calcium carbonate, magnesium oxide, for example. The content rate of first flux is set to the level at which the ceramic base is hardly damaged by the plasma. The content rate of alumina contained in the ceramic base 11 is set to 99 wt % or more (the content rate of the first flux is set to higher than 0 wt % but 1 wt % or less).

In this manner, because the ceramic base 11 whose content rate of alumina is set to 99 wt % or more is used, the content rate of flux contained in the ceramic base 11 is considerably lowered (the content rate of the first flux is set to higher than 0 wt % but 1 wt % or less). Therefore, when the electrostatic chuck 10 is used in a plasma atmosphere, it can be prevented that the ceramic base 11 is damaged by the plasma.

The electrostatic electrode 12 is a single pole electrode, and is built in the ceramic base 11. The ceramic material 13 is provided on a surface 12A of the electrostatic electrode 12. Also, the ceramic material 14 is provided on a surface 12B of the electrostatic electrode 12. For example, when the substrate (not shown) mounted on the substrate mounting surface 11A is charged at a minus potential, the electrostatic electrode 12 is charged at a plus potential, and then the substrate is fixed to the substrate mounting surface 11A. The electrostatic electrode 12 may be formed by burning the conductive past (concretely, the W paste), for example. A thickness of the electrostatic electrode 12 may be set to 20 μm, for example.

The ceramic material 13 is provided to cover the surface 12A of the electrostatic electrode 12. The ceramic material 13 is provided between the electrostatic electrode 12 and a portion of the ceramic base 11 positioned on a side of the substrate mounting surface 11A. The ceramic material 13 contacts the electrostatic electrode 12 and the portion of the ceramic base 11 that faces the substrate mounting surface 11A.

The ceramic material 13 may be formed of alumina and second flux, for example. The content rate of the second flux contained in the ceramic material 13 is set higher than that of the first flux contained in the ceramic base 11. Concretely, when the content rate of the first flux is set higher than 0 wt % but 1 wt % or less, the content rate of the second flux may be set to 4 wt % or more but 10 wt % or less, for example.

In this manner, the second flux is provided between the portion of the ceramic base 11 positioned on the side of the substrate mounting surface 11A and the surface 12A of the electrostatic electrode 12. The ceramic material 13 that contacts the ceramic base 11 and the electrostatic electrode 12 is provided. The content rate of the second flux contained in the ceramic material 13 is set higher than that of the first flux contained in the ceramic base 11. Therefore, the second flux contained in the ceramic material 13 moves to the ceramic base 11 and the electrostatic electrode 12, so that the sufficient anchor effect can be produced between the ceramic base 11 and the electrostatic electrode 12 and the ceramic material 13. As a result, a joint strength between the ceramic base 11 and the electrostatic electrode 12 can be improved. A thickness of the ceramic material 13 may be set to 10 μm, for example.

The ceramic material 14 is provided to cover the surface 12B of the electrostatic electrode 12. The ceramic material 14 is provided between the electrostatic electrode 12 and a portion of the ceramic base 11 positioned on the opposite side to the substrate mounting surface 11A. The ceramic material 14 contacts the electrostatic electrode 12 and the portion of the ceramic base 11 positioned on the opposite side to the substrate mounting surface 11A. The ceramic material 14 has an opening portion 19 that exposes a part of the surface 12B of the electrostatic electrode 12. The opening portion 19 is provided to oppose to the opening portion 17 formed in the ceramic base 11.

The ceramic material 14 may be formed of alumina and the second flux, for example. The content rate of the second flux contained in the ceramic material 14 is set higher than that of the first flux contained in the ceramic base 11. Concretely, when the content rate of the first flux is higher than 0 wt % but 1 wt % or less, the content rate of the second flux content may be set to 4% to or more but 10 wt % or less, for example.

In this manner, the second flux is contained between the surface 12B of the electrostatic electrode 12 and the portion of the ceramic base 11 positioned on the opposite side to the substrate mounting surface 11A. The ceramic material 14 that contacts the ceramic base 11 and the electrostatic electrode 12 is provided. The content rate of the second flux contained in the ceramic material 14 is set higher than the that of the first flux contained in the ceramic base 11. Therefore, the second flux contained in the ceramic material 14 moves to the ceramic base 11 and the electrostatic electrode 12, so that the sufficient anchor effect can be produced between the ceramic base 11 and the electrostatic electrode 12 and the ceramic material 14. As a result, a joint strength between the ceramic base 11 and the electrostatic electrode 12 can be improved. A thickness of the ceramic material 14 may be set to 10 μm, for example.

According to the electrostatic chuck of the present embodiment, the second flux is provided between the electrostatic electrode 12 and the ceramic base 11 that is hardly damaged by the plasma. The ceramic materials 13 and 14 contacting the ceramic base 11 and the electrostatic electrode 12 are provided. The content rate of second flux contained in the ceramic materials 13 and 14 (concretely, 4 wt % or more to 10 wt % or less) is set higher than that of the first flux contained in the ceramic base 11 (concretely, 0 wt % or more to 1 wt % or less). Therefore, the sufficient anchor effect can be produced between the ceramic materials 13 and 14 and the ceramic base 11 and the electrostatic electrode 12. As a result, a joint strength between the electrostatic electrode 12 and the ceramic base 11 that is hardly damaged by the plasma can be improved.

The ceramic material 13 is provided between the surface 12A of the electrostatic electrode 12 and the ceramic base 11. Furthermore, the ceramic material 14 is provided between the ceramic base 11 and the surface 12B of the electrostatic electrode 12. Therefore, a joint strength between the electrostatic electrode 12 and the ceramic base 11 can be improved. Further, a ceramic material may be provided to surround the electrostatic electrode 12. Instead of the ceramic material, a ceramic paste containing the second flux may be provided to surround the electrostatic electrode 12. Also, the ceramic paste may be provided to cover one surface of the electrostatic electrode 12.

Also, in using the ceramic base 11 containing alumina, adhesion between the ceramic base 11 and the ceramic materials 13 and 14 can be improved when alumina is contained in the ceramic materials 13 and 14.

In this case, the content rate of the second flux contained in the ceramic material 13 and that contained in the ceramic material 14 may be set to a different value respectively within a range that is higher than the content rate of the first flux contained in the ceramic base 11.

Also, at least any one of silicon oxide, calcium carbonate and magnesium oxide may be contained in the first and second fluxes.

FIG. 8 to FIG. 14 are views showing steps of manufacturing the electrostatic chuck according to the embodiment of the present invention. In FIGS. 8 to 14, the same reference symbols are affixed to the same constituent portions as those in the electrostatic chuck 10 according to the present embodiment.

A method of manufacturing the electrostatic chuck 10 according to the present embodiment will be described with reference to FIGS. 8 to 14 hereunder. At first, in steps shown in FIG. 8, a first green sheet 25 and a second green sheet 26 are prepared. The first and second green sheets 25 and 26 may be formed of alumina, first flux, binder, plasticizer, and the like. The content rate of alumina contained in the first and second green sheets 25 and 26 may be set to 99 wt % or more (the content rate of the first flux is set to 1 wt % or less). The first flux contained in the first and second green sheets 25 and 26 may be formed of silicon oxide, calcium carbonate, magnesium oxide. The binder may be an organic cement. The plasticizer may be a material that gives flexibility to the first and second green sheets 25 and 26. As plasticizer, for example, polyethylene glycol, dibutyl phthalate may be used.

A thickness of the first green sheet 25 may be set to 1.2 mm, for example. Also, a thickness of the second green sheet 26 may be set to 1.2 mm, for example. The first green sheet 25 may be formed by laminating a plurality of green sheets and thus is set to a desired thickness respectively. The first and second green sheets 25 and 26 are the base material of the ceramic base 11 (see FIG. 2) described above. The first and second green sheets 25 and 26 constitute the ceramic base 11 by burning.

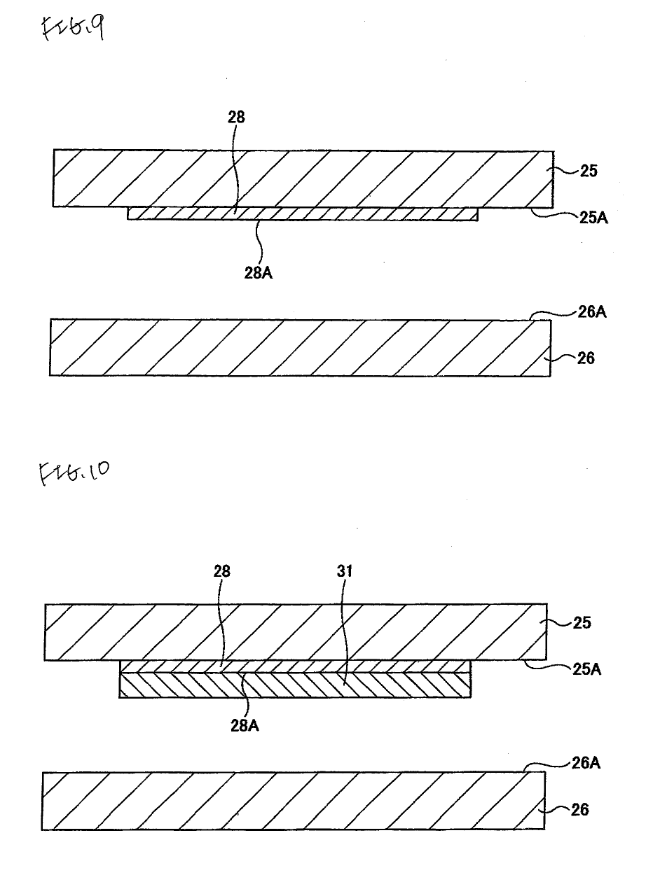

Then, in steps shown in FIG. 9, a first alumina paste 28 is formed on a face 25A of the first green sheet 25 (first alumina paste forming step). Concretely, the first alumina paste 28 is formed by the printing method.

The first alumina paste 28 contains alumina and second flux. The content rate of the second flux contained in the first alumina paste 28 is set higher than that of the first flux contained in the first and second green sheets 25 and 26. Concretely, when the content rate of the first flux is set higher than 0 wt % but 1% or less, the content rate of second flux may be set to 4 wt % or more to 10 wt % or less, for example. A thickness of the first alumina paste 28 may be set to 10 μm, for example. The first alumina paste 28 is the base material of the ceramic material 13 (see FIG. 7) ad described above. The first alumina paste 28 constitutes the ceramic material 13 by burning.

Then, in steps shown in FIG. 10, a conductive paste 31 is formed to cover a surface 28A of the first alumina paste 28 (conductive paste forming step). Concretely, the conductive paste 31 is formed by the printing method. As the conductive paste 31, for example, W paste may be used. A thickness of the conductive paste 31 may be set to 20 μm, for example. The conductive paste 31 constitutes the electrostatic electrode 12 (see FIG. 7) by burning as described above.

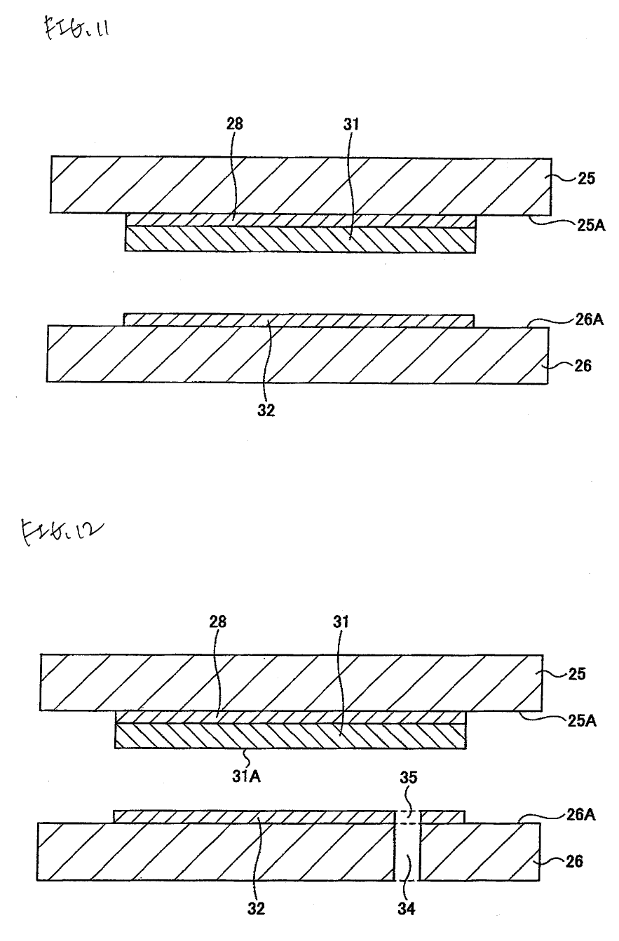

Then, in steps shown in FIG. 11, a second alumina paste 32 is formed on a surface 26A of the second green sheet 26 (second alumina paste forming step). Concretely, the second alumina paste 32 is formed by the printing method.

The second alumina paste 32 contains alumina and the second flux. The content rate of second flux contained in the second alumina paste 32 is set higher than that of first flux contained in the first and second green sheets 25 and 26. Concretely, when the content rate of the first flux is higher than 0 wt % but 1% or less, the content rate of second flux may be set in a range of 4 wt % or more to 10 wt % or less, for example. A thickness of the second alumina paste 32 may be set to 10 μm, for example. The second alumina paste 32 is the base material of the ceramic material 14 (see FIG. 7) as described above. The second alumina paste 32 constitutes the ceramic material 14 by burning.

Then, in steps shown in FIG. 12, a through hole 34 is formed in the second green sheet 26 while a through hole 35 is formed in the second alumina paste 32. The through hole 34 constitutes the opening portion 17 (see FIG. 2) by burning as described above. The through hole 35 constitutes the opening portion 19 (see FIG. 2) by burning as described above.

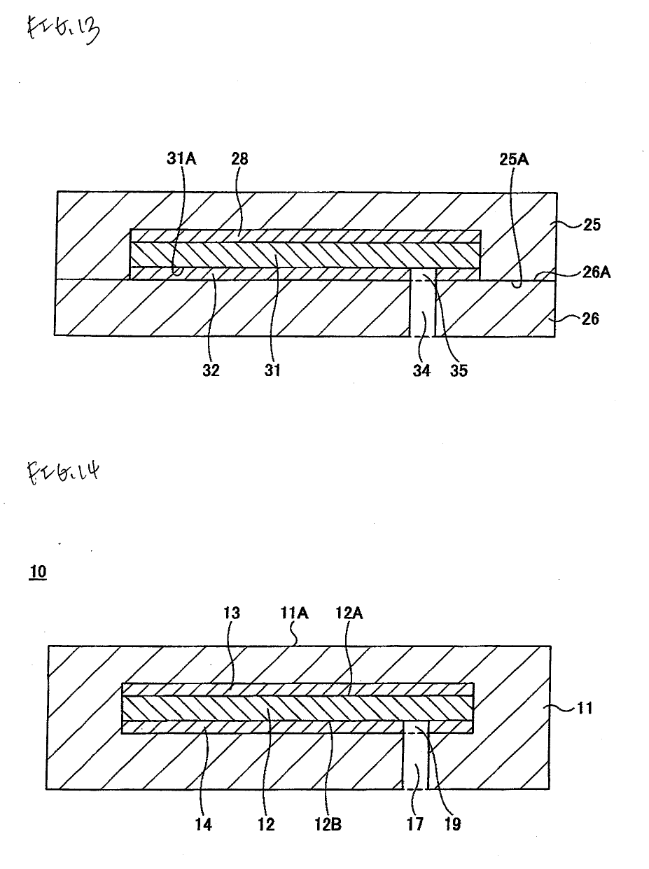

Then, in steps shown in FIG. 13, the first green sheet 25 on which the first alumina paste 28 and the conductive paste 31 are formed and the second green sheet 26 on which the second alumina paste 32 is formed are laminated while applying a pressure such that the second alumina paste 32 contacts a face 31A of the conductive paste 31 (laminating step).

Then, in steps shown in FIG. 14, the structure shown in FIG. 13 is burned (burning step). Accordingly, the electrostatic chuck including the ceramic base 11, the electrostatic electrode 12, and the ceramic materials 13, 14 is manufactured. A burning temperature may be set to 1550° C., for example, and a burning time may be set to 60 hour, for example.

According to the method of manufacturing the electrostatic chuck of the present embodiment, the conductive paste 31 is formed on the first alumina paste 28 provided on the first green sheet 25. The first green sheet 25 on which the first alumina paste 28 and the conductive paste 31 are formed and the second green sheet 26 on which the second alumina paste 32 is formed are laminated such that the first alumina paste 28 contacts the second alumina paste 32. Then, the resultant structure is burned. Further, both the content rate of second flux content contained in the first alumina paste 28 and that contained in the second alumina paste 32 are set higher than that of first flux contained in the first and second green sheets 25 and 26. Therefore, the sufficient anchor effect can be produced between the first alumina paste 28 and the first green sheet 25 and the conductive paste 31 and between the second alumina paste 32 and the second green sheet 26 and the conductive paste 31. As a result, a joint strength between the electrostatic electrode 12 and the ceramic base 11 that is hardly damaged by the plasma can be improved.

Furthermore, the content rate of the second flux contained in the first alumina paste 28 and that contained in the second alumina paste 32 may be set to a different value respectively.

The present invention is applicable to the electrostatic chuck in which the content rate of the flux content contained in the ceramic base is set to the level at which the ceramic base is hardly damaged by plasma, and the method of manufacturing the same.

While the present invention has been shown and described with reference to certain exemplary embodiments thereof, other implementations are within the scope of the claims. It will be understood by those skilled in the art that various changes in form and details may be made therein without departing from the spirit and scope of the invention as defined by the appended claims.

What is claimed is:

1. An electrostatic chuck, comprising:
a ceramic base containing alumina and first flux;
an electrostatic electrode built in the ceramic base; and
a ceramic material containing second flux and provided between the ceramic base and the electrostatic electrode, the ceramic material contacting the ceramic base and the electrostatic electrode;
wherein a content rate of the second flux is higher than that of the first flux.

2. The electrostatic chuck according to claim 1, wherein the ceramic material contains alumina as a principal component.

3. The electrostatic chuck according to claim 1, wherein the content rate of the first flux is set to a level at which the ceramic base is hardly damaged by plasma.

4. The electrostatic chuck according to claim 1, wherein the first flux and the second flux contain at least any one of silicon oxide, calcium carbonate, and magnesium oxide respectively.

5. The electrostatic chuck according to claim 1, wherein the content rate of the first flux is set to 1 wt % or less.

6. The electrostatic chuck according to claim 1, wherein the ceramic material contacts an entire area of at least one of an upper surface of the electrostatic electrode and a lower surface of the electrostatic electrode opposite to the upper surface.

7. A method of manufacturing an electrostatic chuck, the method comprising:
i) preparing first and second green sheets containing alumina and first flux;
ii) forming a first alumina past containing second flux on the first green sheet;
iii) forming a conductive paste on the first alumina past;
iv) forming a second alumina paste containing the second flux on the second green sheet;
v) laminating the first green sheet on the second green sheet such that the conductive paste faces and contacts the second alumina paste; and
vi) burning a laminated structure of the first green sheet and the second green sheet,
wherein a content rate of the second flux is higher than that of the first flux.
